(19) United States
(12) Patent Application Publication
(10) Pub. No.: US 2007/0208541 A1
(43) Pub. Date: Sep. 6, 2007

(54) Method, apparatus, and system for monitoring amount of liquid poured from liquid containers

(76) Inventor: Seth Temko, Prospect Heights, IL (US)

Correspondence Address: ADELI LAW GROUP, A PROFESSIONAL LAW CORPORATION, 1875 CENTURY PARK EAST, SUITE 1360, LOS ANGELES, CA, 90067, US

(21) Appl. No.: 11/368,352

(22) Filed: Mar. 4, 2006

(51) Int. Cl. G06F 11/30

(52) U.S. Cl. 702/186; 222/1

(57) ABSTRACT

Some embodiments provide a method of hosting a social event. The method includes bringing a portable data collector to the event. The method also includes attaching a set of pour monitoring devices (PMDs) to a set of liquid containers. The method transmits liquid pour information from PMDs to the portable event data collector. The method time-stamps and saves the pour data by the event data collector. The method transfers the saved pour data from the event data collector to a data collection computer that is communicatively coupled to the event data collector. In some embodiments, the communicatively coupling of the portable event data collector and the data collection computer is performed after the event by taking the event data collector to proximity of the data collection computer and linking them through a wireless communication connection.

### FIELD OF THE INVENTION

The present invention is directed towards method, apparatus, and system for monitoring amount of liquid poured from liquid containers.

### BACKGROUND OF THE INVENTION

The amount of liquids dispensed from liquid containers need to be monitored for many endeavors today. For instance, the management of establishments such as bars and taverns has long found it necessary to carefully monitor the relationship between liquid dispensed and receipts by controlling the quantity of liquid dispensed from a specific container and recording the sale.

A few systems have been proposed to date for measuring and recording the amount of liquid dispensed from liquid containers. One such system includes a pour spout that is configured to attach to an opening of a liquid container. This spout also uses a portion-control mechanism to control the desired amount of liquid poured from the liquid container. The spout includes a radio transmitter for emitting signals containing activity information. A receiver receives the transmitted signals, and provides these signals to a computer at the establishment that processes the signals into the text for viewing.

Another system includes a free-pour spout that mounts on an open orifice of a liquid container and measures the amount of liquid poured from the liquid container. This spout has a housing and a passageway defined within the housing. It also has a detection circuit that detects fluid flow through the passageway. In addition, this spout has a measuring circuit that generates data relating to fluid flow when the detection circuit detects fluid flow through the passageway.

In none of these systems the spout is capable of detecting to which liquid container it is attached to. Therefore, there is a need for a system in which an electronic device automatically detects and reports the identification of the liquid container to which it is attached to. There is also a need for a receiving system to selectively monitor certain containers in order to allow several monitoring systems to operate in close proximity of each other.

### SUMMARY OF THE INVENTION

Some embodiments provide a method of hosting a social event. The method includes bringing a portable data collector to the event. The method also includes attaching a set of pour monitoring devices (PMDs) to a set of liquid containers. The method transmits liquid pour information from PMDs to the portable event data collector. The method time-stamps and saves the pour data by the event data collector. The method transfers the saved pour data from the event data collector to a data collection computer that is communicatively coupled to the event data collector.

In some embodiments, the communicatively coupling of the portable event data collector and the data collection computer is performed after the event by taking the event data collector to proximity of the data collection computer and linking them through a wireless communication connection.

### BRIEF DESCRIPTION OF THE DRAWINGS

The novel features of the invention are set forth in the appended claims. However, for purpose of explanation, several embodiments are set forth in the following figures.

FIG. 1 conceptually illustrates the catering version of the liquid monitoring system of some embodiments.

FIG. 2 conceptually illustrates the liquid monitoring system of some embodiments with a computer as an all-in-one data collector.

FIG. 3 conceptually illustrates the liquid monitoring system of some embodiments with a custom-made all-in-one data collector.

FIG. 4 illustrates the catering system and data collection of some embodiment.

FIG. 5 illustrates an antenna used by some embodiments.

FIG. 6 illustrates the catering system and data collection of some embodiment that utilize RFID tags.

FIG. 7 illustrates an example of a catering system of some embodiments.

FIG. 8 illustrates an example of a catering system of some embodiments that utilize RFID tags.

FIG. 9 illustrates a process utilized by the event data collector in some embodiments.

FIG. 10 conceptually illustrates a process that is used by some embodiments to program data collectors to recognize certain pour monitoring devices.

FIG. 11 illustrates a process used by the Data Collection computer of some embodiments.

FIG. 12 conceptually illustrates a method of hosting an event in some embodiments.

FIG. 13 illustrates an example of an all-in-one system of some embodiments that use an off-the-shelf computer and external printer.

FIG. 14 illustrates an example of an all-in-one system of some embodiments that use an off-the-shelf computer, an external printer, and RFID tags.

FIG. 15 illustrates an example of an all-in-one system of some embodiments that use a custom-made data collector.

FIG. 16 illustrates an example of an all-in-one system of some embodiments that use a custom-made data collector.

FIG. 17 illustrates a process used by the all-in-one data collector of some embodiments.

FIG. 18 illustrates a process used by some embodiments for reading and reporting container RFID tag information by a pour monitoring device that has memory to save RFID information.

FIG. 19 illustrates a process used by some embodiments for reading and reporting container RFID tag information by a pour monitoring device that does not save RFID information.

FIG. 20 illustrates a process used by some embodiments for programming container RFID tag information by a pour monitoring device.

FIG. 21 illustrates an electronics system utilized in some embodiments.

### DETAILED DESCRIPTION OF THE INVENTION

In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail.

Some embodiments provide a method of hosting a social event. The method includes bringing a portable data collector to the event. The method also includes attaching a set of pour monitoring devices (PMDs) to a set of liquid containers. The method transmits liquid pour information from PMDs to the portable event data collector. The method time-stamps and saves the pour data by the event data collector. The method transfers the saved pour data from the event data collector to a data collection computer that is communicatively coupled to the event data collector.

In some embodiments, the communicatively coupling of the portable event data collector and the data collection computer is performed after the event by taking the event data collector to proximity of the data collection computer and linking them through a wireless communication connection.

Some embodiments of the invention provide a system for monitoring liquid consumption at an establishment. The system includes a set of PMDs and a set of electronics identification tags for storing electronics information in them. Each PMD mounts on a liquid container and generates data regarding the amount of liquid poured from the container. An electronic identification tag attaches to a liquid container. Each PMD is communicatively coupled to the electronics identification tag that is attached to the container on which the particular PMD is mounted.

Several more detailed embodiments of the invention are described in sections below. Before describing these embodiments further, an overview of these embodiments is given in Section I below. Section I also gives an overview of pour monitoring devices and electronics tags attached to some of the liquid containers. Next, Section II describes the catering embodiment of the monitoring system. This discussion is followed by Section III description of the embodiments that use an all-in-one data collector unit. Next, Section IV describes interactions of the pour monitoring devices and their corresponding electronics tags. Last, Section V describes a computer which is utilized in some of the embodiments of the invention.

I. Overview

A. Overall System

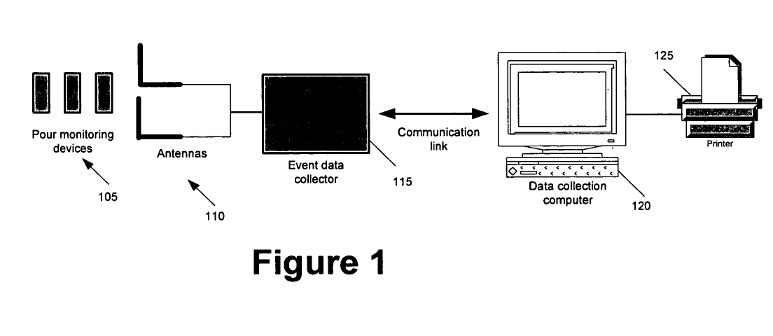

Several embodiments of the liquid monitoring system are described below. In some embodiments, the liquid monitoring system is configured to operate as a catering system for events. During an event, the system collects liquid consumption data. Later on, the data is transferred to a computer which would store the data and generate reports. A conceptual example of a liquid monitoring system configured for events is illustrated in FIG. 1. As shown, the system includes a set of pour monitoring devices 105, and a set of antennas 110 that are connected to an event data collector 115. Each pour monitoring device 105 is attached to an opening of a liquid container (e.g., on a bottle of liquor or soft drink) and communicates with the event data collector 115 through the antennas 110. The event data collector is easily transported to and from events. The event data collector 115 communicates with a data collection computer 120 to transmit collected data. This transmission can either be live while the event is going on or can be done after the event. The data collection computer 120 collects data from different event data collectors and generates reports. The computer 120 is optionally connected to an external printer 125.

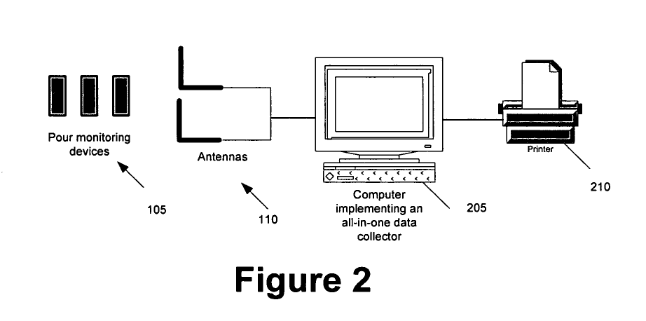

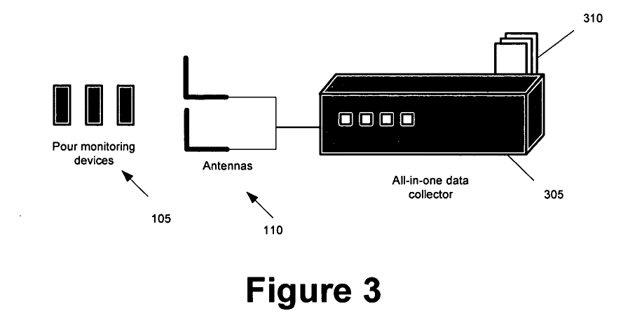

In other embodiments, the liquid monitoring system is configured as a stand-alone system which is capable of collecting data from the pour monitoring devices, storing the data, and generating reports. FIG. 2 illustrates one such embodiment in which an off-the-shelf computer 205 is used to collect data sent by the pour monitoring devices 105. The computer 205 uses an external printer 210 to generate printed reports. FIG. 3 illustrates another embodiment of a stand-alone system in which a custom-made data collector 305 is utilized to collect information sent by the pour monitoring devices 105. In some embodiments, the custom-made data collector 305 has an internal printer 310. In other embodiments, an external printer (not shown) may be used. All three systems shown in FIGS. 1-3 can transfer their data to other remote computers that aggregate data from several catering and/or stand-alone systems.

B. Pour Monitoring Devices

In some embodiments, the pour monitoring device (PMD) is a pour spout. PMDs other than spouts are described further below. Each spout is configured to attach to an opening on a liquid container. Each spout includes a measuring apparatus and a wireless transceiver. In some embodiments, instead of a transceiver, the spout includes a transmitter that is only capable of transmitting (and not receiving data). The measuring apparatus provides data relating to the amount of liquid poured from the container affixed to its spout. In some embodiments, the spouts are free-pour spouts, allowing liquid to be poured without restricting flow or limiting quantities. In other embodiments, the spouts are restricted pour spouts, limiting liquid to be poured to a certain per-determined quantity.

Each spout contains a unique microchip that transmits pour data via radio frequency to a data collector unit. Each microchip has a unique code, enabling each spout to be tracked individually. Detail description of the above mentioned spout functions is described in the U.S. Pat. No. 6,892,166, entitled “Method, Apparatus, and System for Monitoring Amount of Liquid Poured from Liquid Containers” issued on May 10, 2005 and U.S. Pat. No. 6,036,055 entitled, “Wireless Liquid Portion and Inventory Control System” issued on Mar. 14, 2000. These two applications are fully incorporated herein by reference.

In some embodiments, the PMD is not a spout and attaches to the side of the container by, for example, a strap or an adhesive. In these embodiments, the PMD does not measure or control liquid flow. Instead, the amount poured is estimated by the time the container is tilted, as measured by a sensor in the PMD and communicated to an external system. In another embodiment of a PMD, the PMD functions are similar to the side-mounted PMD, except that the PMD is affixed to the bottom of the container. The PMD may be mounted to the container by a clip, an adhesive or as a cup that is attached to the bottom of the container. In addition to the functions of the side-mounted PMD, the bottom-mounted PMD, in some embodiments, also detects when the container is picked up or set down. Also, in some embodiments, the PMD is located inside the container (e.g., inside the neck or body of a bottle).

In some embodiments, the PMD is part of a liquid dispensing system. In such a system, a container, such as a bottle, is inverted into a pumping system located in a storage area. Liquid from the bottle is pumped to a dispensing gun at the point of sale, such as a bar. A PMD local to the pump reads the tag on the bottle and sends the tag information to a data collector.

In some embodiments, the PMDs are capable of communicating on different frequencies (e.g., to comply with different regions radio frequency requirements). For instance, in some embodiments, the PMDs may operate both in 418 MHz and 433.92 MHz frequencies. In other embodiments, the PMDs may operate in other frequencies. A person of ordinary skill in the art would recognize that other frequencies may also be required in different regions of the world and the PMDs can be modified to operate in proper frequencies.

In some embodiments, each PMD includes electronics for controlling or measuring liquid flow or a chronometer for measuring time of tilt. The PMDs also include antennas for communication with an external system, such as a data collector. More information about the PMDs is given in the concurrently filed U.S. Patent Application, Attorney Docket No. CPTN.P0006, entitled “System for Beverage Dispensing and Sales Tracking,” filed on Mar. 4, 2006. This application is incorporated herein by reference.

C. RFID Tags

In some embodiments, the PMD also communicates with an identification tag attached to the liquid container. In some embodiments, each container of liquid is fitted with a Radio Frequency IDentification (RFID) tag (although in several following examples the identification tag is referred to as an RFID tag, a person of ordinary skill in the art will realize that the invention may be practiced with identification tags other than RFIDs). An RFID tag is a small object that can be attached to or incorporated into an object. RFID tags contain antennas to enable them to receive and respond to radio-frequency queries from an RFID transceiver. RFID tags may be passive or active. Active tags require a power source and may have the ability to store additional information sent by the transceiver. Passive tags require no internal power source and do not have the ability to store additional information received from the transceiver. RFID tags also can be writable, read-only, or a combination. In a writeable tag, stored data can be changed. In a read-only tag, stored data can be read but not modified. Some tags may be a combination of read-only and writeable, i.e., some data is permanently stored while the rest of the memory is left accessible for later updates.

In some embodiments, RFID tags include information about the liquid container they are affixed to. For instance, the information may include the manufacturer name, product type, container size, etc. In some embodiments, the RFID tag may include a serial number that allows looking up in a database for more information about the liquid container (e.g., shipping information or manufacturer address). Also, in some embodiments information from secondary devices may be appended to the information already on a tag. For instance, temperature, humidity, warehouse identification number, storage locker room identification, identification of a person pouring liquid or handling the container may all be read from other RFID tags and appended to the information on an RFID tag. In some embodiments, the tag is fabricated as part of the label. In some embodiments, the tag may be located in other locations on the outside or inside of the container, not associated with the label, such as on the neck, on the bottom, or on the side. In some embodiments, the tag is fabricated as part of the container, e.g., embedded in part of a glass or plastic container. More information about the use of RFID tags in a liquid monitoring system is given in the above mentioned concurrently filed U.S. Patent Application, Attorney Docket No. CPTN.P0006.

II. Catering System

A. Overall System

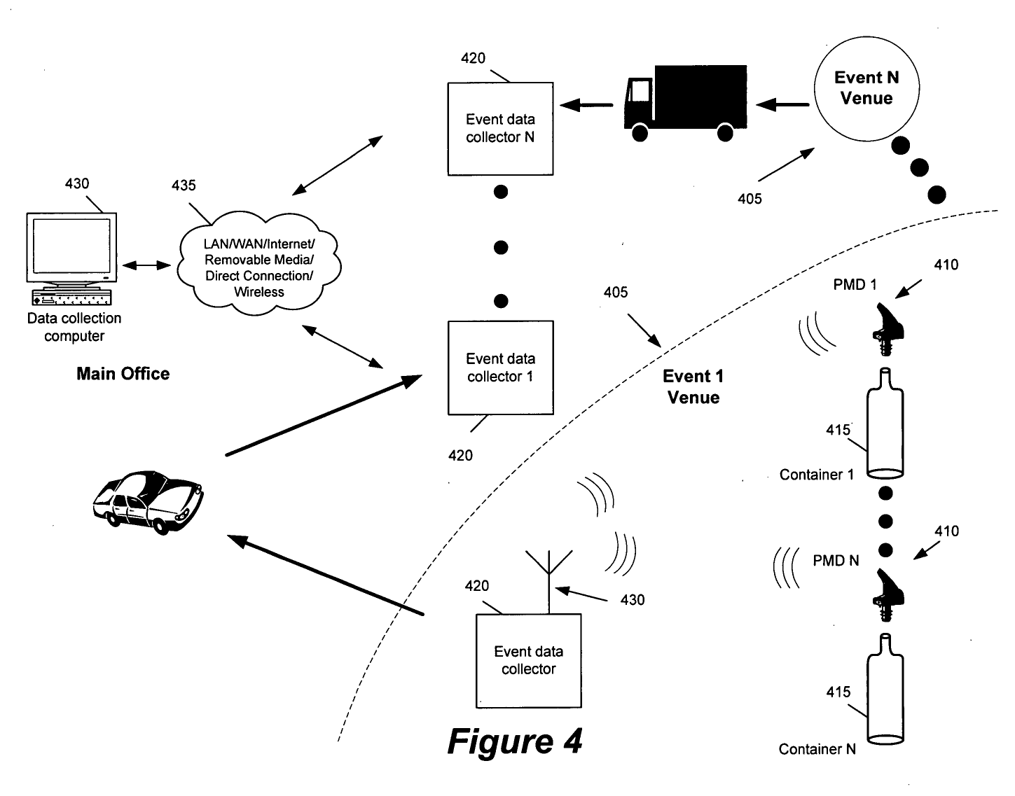

FIG. 4 illustrates an example of the liquid monitoring system designed to be used in events. The liquid monitoring system allows monitoring of liquid consumption at several events 405. At each event 405, the system includes one or more PMDs 410, one or more liquid containers 415, and an event data collector 420. Although FIG. 4 and several following figures show a spout 410 as an example of a PMD, as described above, in some embodiments, the PMD is not a spout and the invention can be practiced without the use of spouts. Each PMD is configured to attach to a liquid container 415. Each PMD 410 is communicatively coupled to the event data collector and to the PMD's corresponding liquid container 415.

As shown in FIG. 4, each PMD 410 communicates with the event data collector 420 via an antenna 430 connected to the event data collector. In some embodiments, more than one antenna is connected to the same event data collector. When the radius of one antenna is not large enough to communicate with all PMDs, additional antennas would allow a larger coverage area.

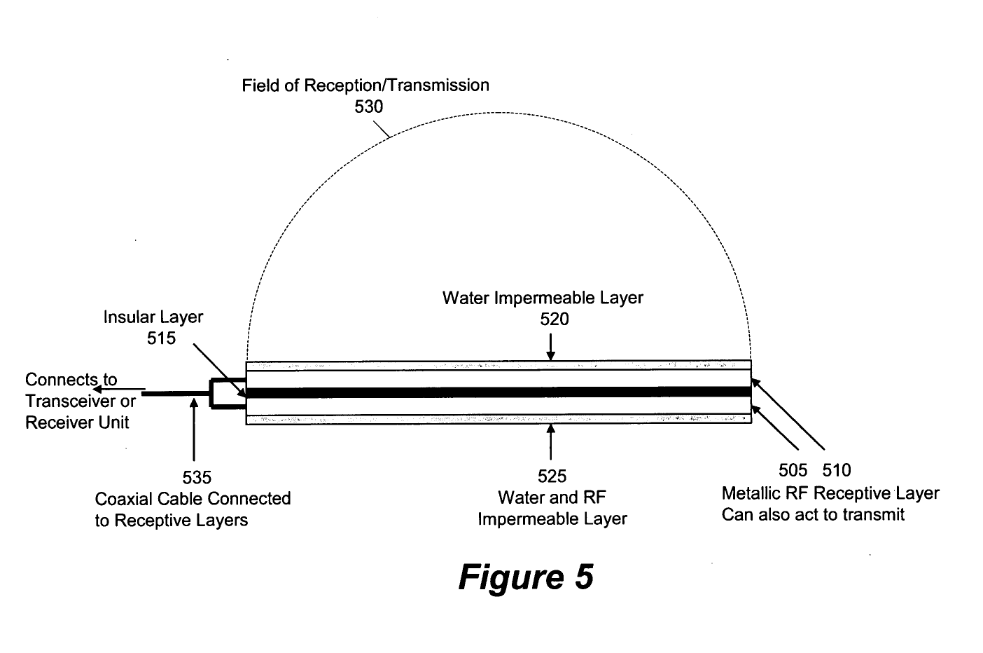

FIG. 5 illustrates an antenna 500 of some embodiments. As shown, the antenna, referred herein as a matt antenna, includes two metallic RF receptive layer 505 and 510 layers separated by an insular layer 515. In some embodiments, the two RF receptive layers 505 and 510 also act to transmit. The three layers 505-515 are placed within two layers of liquid (e.g., water) impermeable material 520 and 525. In some embodiments, the lower layer 525 is also RF impermeable. The antenna has a hemispherical reception/transmission pattern above the two conductive layers. This hemispherical reception pattern is conceptually illustrated in FIG. 5 as the dashed curve 530. A person of ordinary skill in the art will realize that the actual reception area may not be a perfect hemisphere.

As shown, the two RF receptive layers 505 and 510 are connected to a transceiver (or in some embodiments to a receiver) by a connector 535 such as a coaxial cable. As described below, the transceiver (or receiver) is a component of the data collector. The matt antenna 500 is placed on the bar surface (with the water and RF impermeable layer 525 facing down) and the liquid is poured from the containers directly above the matt. In some embodiments, the range of antenna is limited by adding an attenuator (not shown) into the connecting cable.

The use of the antenna shown in FIG. 5 is not limited to the liquid monitoring system. The antenna can be used for other applications. For instance, the antenna can be placed on any surface that may get wet or where liquids may be spilled on. The antenna can be connected by a wire to a transceiver, receiver, or transmitter. A person of ordinary skill in the art would realize that the invention can be practiced by using other kind of RF antennas. Also, in some embodiments, the event data collector has an additional built-in antenna. For instance, the built-in antenna may be a retractable antenna that is deployed whenever a lid is open. The built-in antenna allows for quick deployment of the catering system.

As illustrated in FIG. 4, event data collectors 420 are portable and may be transported out of the event venue, e.g., to a main office location. The event data collectors may be communicatively coupled to a data collection computer 430 to upload data collected during different events. As will be described below, the event data collectors 420 and the data collection computer 430 may be coupled via different media such as Local Area Networks (LAN), Wide Area Networks (WAN), Internet, or similar networks. Other methods of exchanging data such as direct connection, removable media, wireless connection, etc. are also feasible.

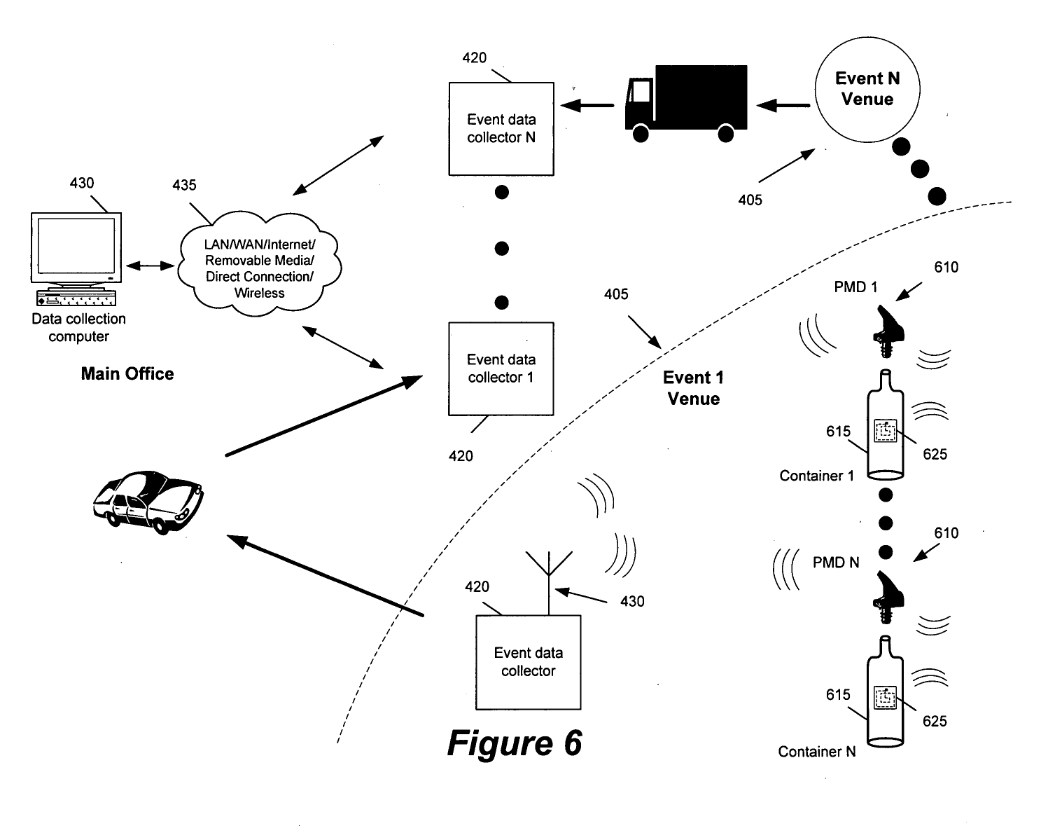

FIG. 6 illustrates another embodiment of the catering system. This system is similar to the system illustrated in FIG. 4 with the additional feature that the PMDs 610 communicate with RFID tags 625 that are fitted on the liquid containers 615. As shown, in order to communicate with the PMD 610, each container of liquid 615 is fitted with an RFID tag 625. Each PMD communicates with the RFID tag on the particular container that the PMD is attached to. Other functions of the PMDs 610 are similar to the PMDs 410 described above.

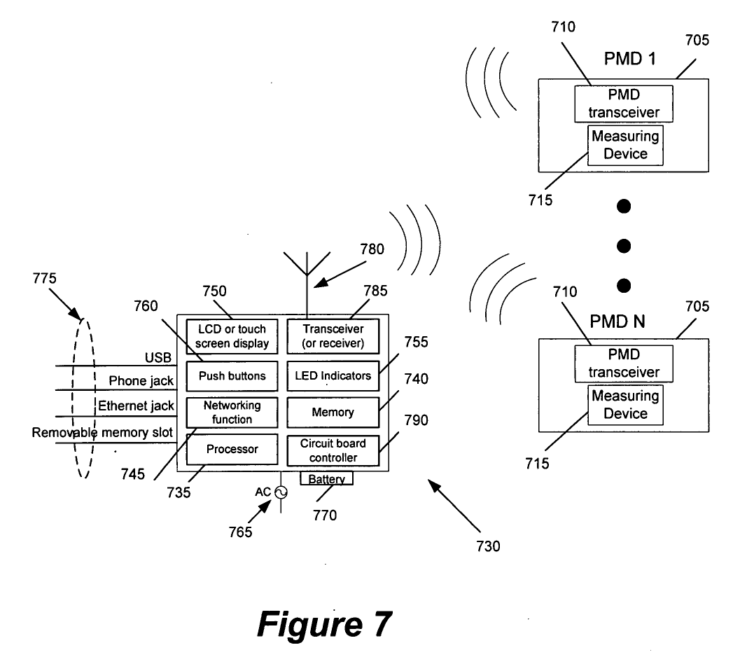

FIG. 7 illustrates an example of different components of a liquid monitoring system of some embodiments. As shown, the system includes a set of PMDs 705. Each PMD has a transceiver (or in some embodiments, a transmitter) 710. The PMD transceivers 710 communicate with the event data collector 730. In some embodiments, each PMD also has a measuring device 715. However, as described above, some PMDs (not shown) do not have a measuring device. In the embodiments that the PMD includes a measuring device, the measuring device 715 measures the amount of liquid that is poured from the corresponding container (not shown).

FIG. 7 also illustrates an example of an event data collector unit 730. The event data collector unit 730 includes a processor 735, memory (both volatile and non-volatile) 740, networking function 745 (either built-in networking capability or a network card), an LCD display (some embodiments have a touch screen instead of the LCD display) 750, a set of LED indicators 755, a set of push buttons (and/or a keyboard) 760, and a circuit board controller 790 to handle I/O and data communication. The event data collector unit 730 also has an AC adaptor 765 as well as battery backup 770. As shown, the event data collector unit has a radio transceiver (or in some embodiments, a receiver) 785 that is used to connect to an antenna 780. In some embodiments, the antenna is connected to the transceiver by an F-connector or a similar connector. As described above, more than one antenna may be connected to an event data collector. Also, some embodiments have an additional built-in antenna. The unit 730 also has a set of communication ports 775 to communicate with external computers such as a data collector computer 430 that was described above with reference to FIG. 4. The communication ports include USB, phone jack, Ethernet jack, removable memory slot, etc. In some embodiments, the data collector may have a scanner (not shown) to scan the UPC codes of liquid containers.

In some embodiments, the LED indicators 755 allow rapid assessment of the unit's status. For instance, the LED indicators may indicate the battery status, whether the unit is connected to AC power, whether unit recognizes an Ethernet outlet, whether the unit is connected to the antenna, and whether the unit has data to transmit to a data collector computer. Some embodiments also provide for audible tunes. For instance, a tune may periodically sound when the battery is low, when the unit is (or is not) connected to AC power, when the unit recognizes an Ethernet outlet, when the unit is in wireless contact with a data collector computer, when the unit is connected to the antenna, or when the unit has data to transmit to a data collector computer.

In order to make the event data collector unit compact and portable, some embodiments limit the size of the LCD display 750 to a few lines. In some embodiments, the LCD display is limited to 10 lines or less. Yet, in some other embodiments, the event data collector may not have a display 750 and communicates with the operator through a set of light indicators (e.g., the LED indicators 740). Also, some embodiments may limit the number of push buttons 760 to a few to allow an operator to select from a set of options presented on the screen and to enter a limited number of input characters. In some embodiments, the push buttons 760 are used in lieu of a computer based keyboard (e.g., a QWERTY keyboard).

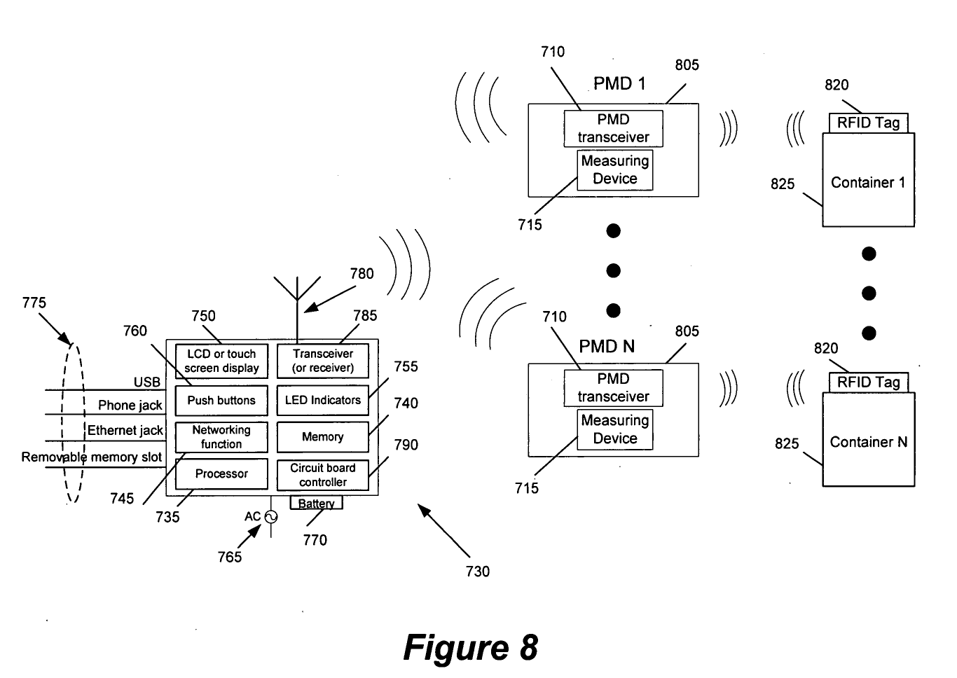

FIG. 8 illustrates another example of a liquid monitoring system of some embodiments. This system is similar to the system illustrated in FIG. 7 with the additional feature that the PMDs 805 communicate with RFID tags 820 that are fitted on the liquid containers 825. As shown, in order to communicate with the PMD 805, each container of liquid 825 is fitted with an RFID tag 820. Each PMD communicates with the RFID tag on the particular container that the PMD is attached to. Other functions of the PMDs 805 are similar to the PMDs 705 described above.

Although the above examples are described with reference to specific components, a person of ordinary skill in the art would realize that other similar components may be utilized. For instance, instead of a set of push button keys, a keyboard may be used. The LCD display may be replaced with other types of displays such as a small CRT monitor or a touch screen. A PMD may or may not be a pouring spout. The LED indicators may be utilized to show other system status. Also, some embodiments may not have all communication ports that are shown in FIGS. 7 and 8 or may have other communication ports known to a person of ordinary skill in the art.

B. Event Data Collector Functions

1. Receiving and Transmitting PMD Data

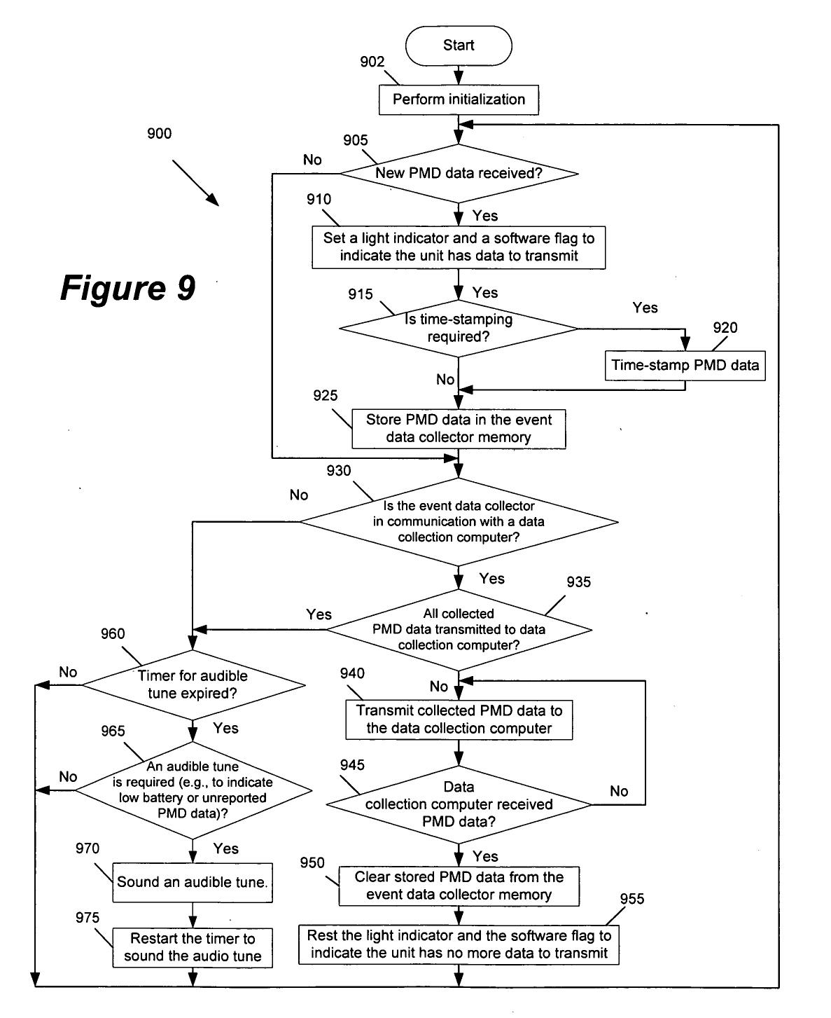

FIG. 9 conceptually illustrates a process 900 of the event data collector (730) of some embodiments. As described above, the event data collector (730) is utilized in the catering embodiment of the liquid monitoring system. At 902, when process 900 is first started, the process performs initialization. For instance, some embodiments sound an audible tune to alarm an operator of certain system status. As a part of initialization, the process 900 starts a timer to periodically check if an audible tune is required. The use of this timer is described below.

Next (at 905), the process checks if new PMD data is received. If no new data has been received, the process proceeds to 930 which is described below. Otherwise, the process sets a light indicator (e.g., turns an LED light on) and sets a software flag to indicate that the unit has data to transmit. The process then checks (at 915) whether time-stamping is required. In some embodiments, the event data collector does not time-stamp the data if the event data collector is in real-time communication with a data collection computer. In these embodiments, the data collector does not time-stamp the data and the process proceeds to 925. Otherwise, the process time-stamps (at 920) the data received from the PMD. In some embodiments, the PMD does not have an internal clock. In these embodiments, the PMD keeps track of the elapsed time by maintaining an internal chronometer as a time index. For instance, the PMD may utilize the chronometer to measure the elapsed time of a pour. The PMD appends this time index to the data sent to the data collector. The process 900 utilizes the time index received from the PMD to calculate the actual date and time for the collected data and time-stamps the data with the date and time of the event. Next (at 925), the process stores the PMD data in non-volatile memory.

Next (at 930), the process checks whether the event data collector is in communication with a data collection computer (e.g., with the main office data collection computer, 430). The event data collector and the data collection computer may have different ways of communication. For instance, in some embodiments, when the event data collector is brought to the proximity of the data collection computer, the two systems establish wireless communication. In these embodiments, the two units perform a handshake to establish communication. The event data collector informs the data collection computer that the event data collector has PMD data to transmits. The data collection computer then sends a command to request the data to be transferred.

In other embodiments, the two systems may communicate via Internet, direct connection, WAN, LAN, or similar means. For instance, in some embodiments, the event data collector recognizes that it is connected to the Ethernet (i.e., to the LAN). The event data collector may then either transmit its data to the data collection computer on a regular schedule which can be programmed by the operator. Alternately, the two units may also perform a handshake as described above to establish communication. In some embodiments, a certain phone number (e.g., a toll free number) may be available for event data collectors to dial to connect to a data collection computer.

In some embodiments a portable medium such as a removable memory or a USB operated device (such as a jump drive) is utilized to transfer data between the event data collector and the data collection computer. In these embodiments (not shown in FIG. 9), a push button or a menu option on the LCD display is utilized to clear the stored PMD data from the event data collector memory. The same push button or menu option is also used to reset/turn off the indications (software flag and LED light) that the event data collector has PMD data to transmit.

After 1130, if the systems are in communication, the process proceeds to 935 which is described below. If there is no communication between the event data collector and the data collection computer, the process checks (at 960) whether the timer for sounding the audible has expired. If the timer is not expired, the process proceeds to 905. Otherwise, the process checks (at 965) whether an audible tune is required.

As described above, some embodiments sound an audible tune to alert the operator with certain status condition, e.g., when the event data collector has new PMD data to transmit to the data collection computer or when the battery is low. With the exception of the availability of new PMD data which is determined by process 900 (at step 910) all other status information are sensed by a set of sensors. These sensors inform the event data collector processor of the specific status. For instance, if the unit is disconnected from AC power, the sensor informs the processor. Subsequently, when the unit is connected to the AC power, the processor is informed again. The processor is informed (not as a part of process 900) by the sensor through either an interrupt or similar methods known by a person of ordinary skill in the art. The processor sets or resets a series of software flags which are later on used by process 900 to sound the audible tune (the processor also turns the corresponding LED lights on or off to indicate the status). Therefore, at 965, the process 900 checks these software flags to determine if an audible tune is required. If no tune is required, the process proceeds to 905. Otherwise, at 970, the process sounds an audible tune. Next (at 975), the process restarts the timer for the audio tune. The process then proceeds back to 905.

If after 930, the process proceeds to 935, the process checks whether all previously collected PMD data is transmitted to the data collection computer. If all data is already transmitted, the process proceeds to 960 which was described above. Otherwise, the event data collector (730) transmits (at 940) the collected PMD data to data collector computer 430.

Next (at 945), the event data collector checks whether the data collection computer has received the PMD data. In some embodiments, the event data collector counts the number of bytes of data to transfer and inquires from the data collection computer whether the total number of bytes has been arrived. Other embodiments may use other methods, e.g., utilize an end of file control character, to determine if all data bytes are transferred. If the transmission was not successful, the process returns to 940 to retransmit the data. In some embodiments, the retransmission is repeated (not shown in FIG. 9) for a predetermined number of times before an error condition is generated. If the transmission was successful, the process proceeds to 950.

At 950, the process clears the stored PMD data from the event data collector memory. Next (at 955), the process resets the light indicator and the software flag to indicate that the unit has no more data to transmit. The process then proceeds back to 905.

In some embodiments, the event data collector also keeps tracks of the PMDs that are communicating with it and generates an alarm when the PMD is taken out of the range of the event data collector. The alarm may be in the form of an audible sound, an indicator light turned on, a display message, or an alarm internally kept within the system.

2. Programming Data Collectors to Recognize Certain PMDs

In some embodiments, the event data collector is programmed to recognize only a subset of the PMDs. There are situations where more than one event data collectors may be operating in close proximity of each where there are signal overlapping for their corresponding PMDs. For instance, in a large ballroom, there may be bars in each corner of the room and more than one event data collectors may be needed to operate in the room. Also, a large banquet room may be divided by a temporary partition where two or more event data collectors are collecting PMD data for different events.

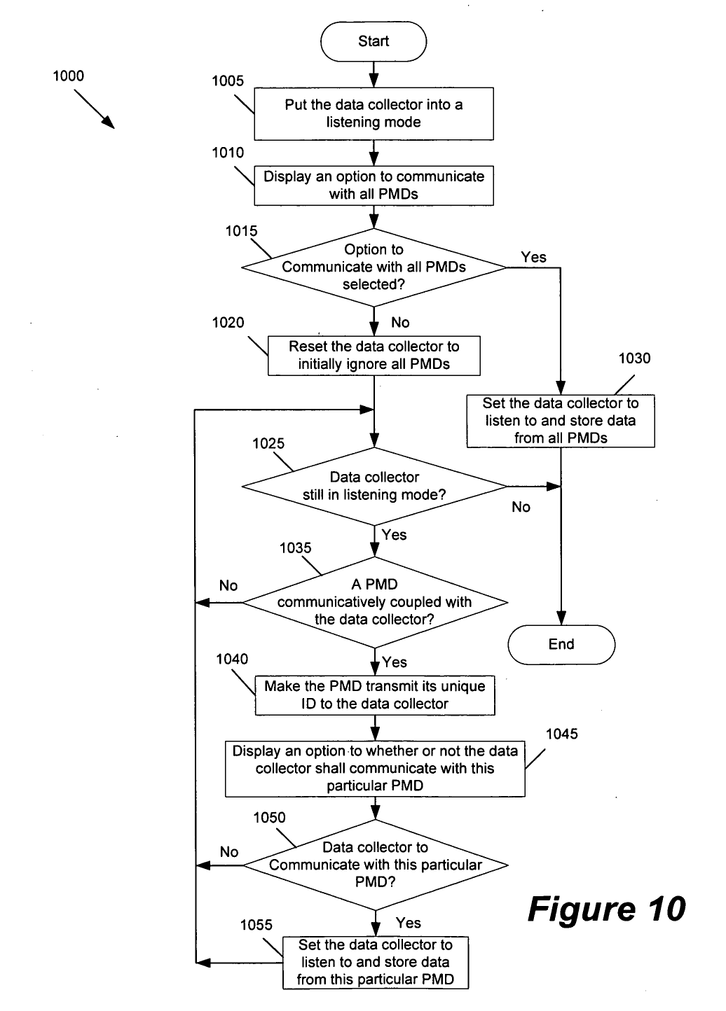

In these cases, through selections on the LCD display (or other displays described above), the operator may program the event data collector to communicate with a subset of PMDs. Later on, using the selections, the operator may program the event data collector to communicate with all PMDs. FIG. 10 conceptually illustrates a process 1000 that is used by some embodiments to program data collectors to recognize certain PMDs. As shown, (at 1005) the event data collector is first put into a listening mode. In some embodiments, this is done by pushing a button by the operator. In other embodiments, this is done by selecting an option displayed on the display screen. In some embodiments, the data collector in the listening mode has a shorter receiving range (than in normal mode) to enable it to communicate with PMDs brought to its proximity one at a time.

At 1010, the process displays an option to program the data collector to communicate with all PMDs. In some embodiments, the data collector displays the options on a display screen. In other embodiments, the data collector turns on one of several light indicators to display an option. At 1015, if the option is selected (in some embodiments, instead of displaying an option, the selection is done by pushing a button by the operator), the process sets the data collector (at 1030) to listen to and store data from all PMDs. The process then exits.

Otherwise, the process resets the data collector (at 1020) to initially ignore all PMDs. The process then checks (at 1025) if the data collector is still in listening mode. If not, the process exits. In some embodiments, if the data collector is set to ignore all PMDs without setting it to listen to at least one PMD, a warning is displayed (not shown in FIG. 10) for the operator. If the data collector is still in listening mode, the process checks (at 1035) whether a PMD is communicatively coupled with the data collector. This can be done, for instance by brining a PMD to proximity of the data collector. The PMD is then made (at 1040) to transmit its unique ID to the event data collector. If a PMD is not communicatively coupled with the data collector, the process proceeds to 1025 that was described above.

Next (at 1045), the data collector displays an option to whether or not the data collector shall communicate with that particular PMD. At 1050, the operator would choose (e.g., by touching a selection on a touch screen or through the selections displayed and by pushing a button) whether the data collector should communicate with that particular PMD. If the operator chooses to ignore the PMD, the process proceeds to 1025 that was described above. Otherwise, the process sets the data collector (at 1055) to listen to and store data from this particular PMD.

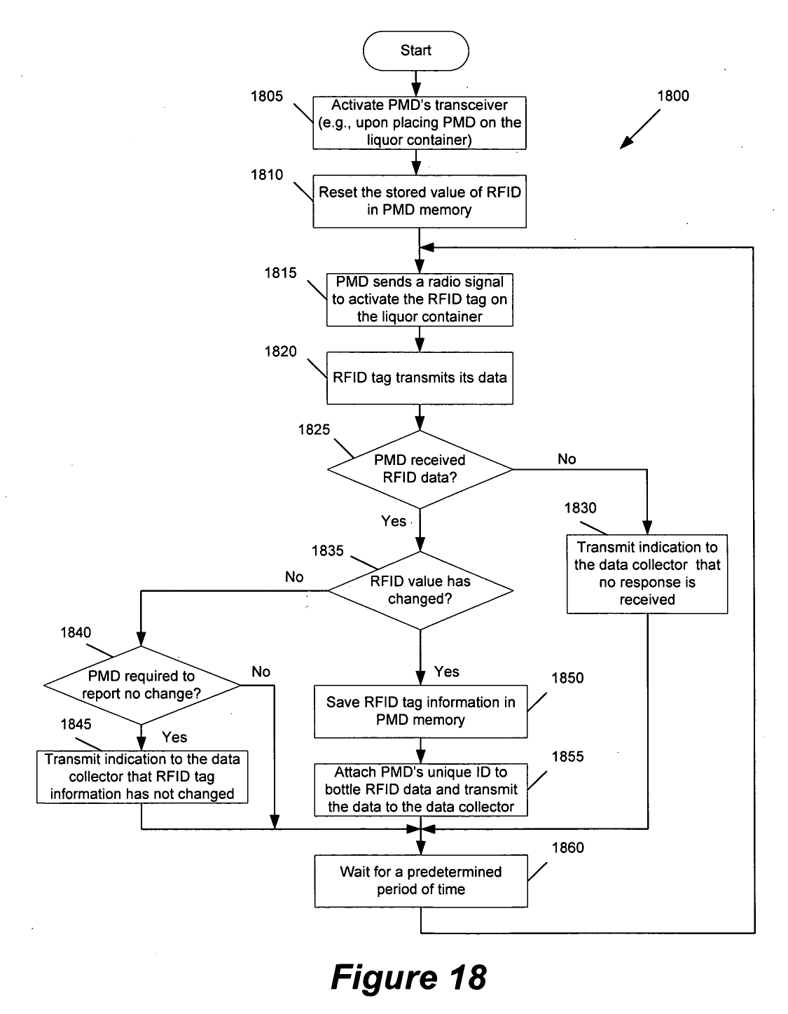

Also, in some embodiments, the PMDs are paired with the liquid container. This can be done during process 1000 or as a separate process. For instance, in the embodiments that the liquid container has an RFID tag, the RFID tags are read by the PMD (e.g., by using process 1800 in FIG. 18, described below) and reported to the data collector. In other embodiments, a UPC code on the container may be scanned (hand scanned or scanned by the data collector) and used to mate the container to its corresponding PMD. After the programming is done, the data collector will only store data from the PMDs with particular ID and will ignore all other PMDs' data.

C. Data Collection Computer Functions

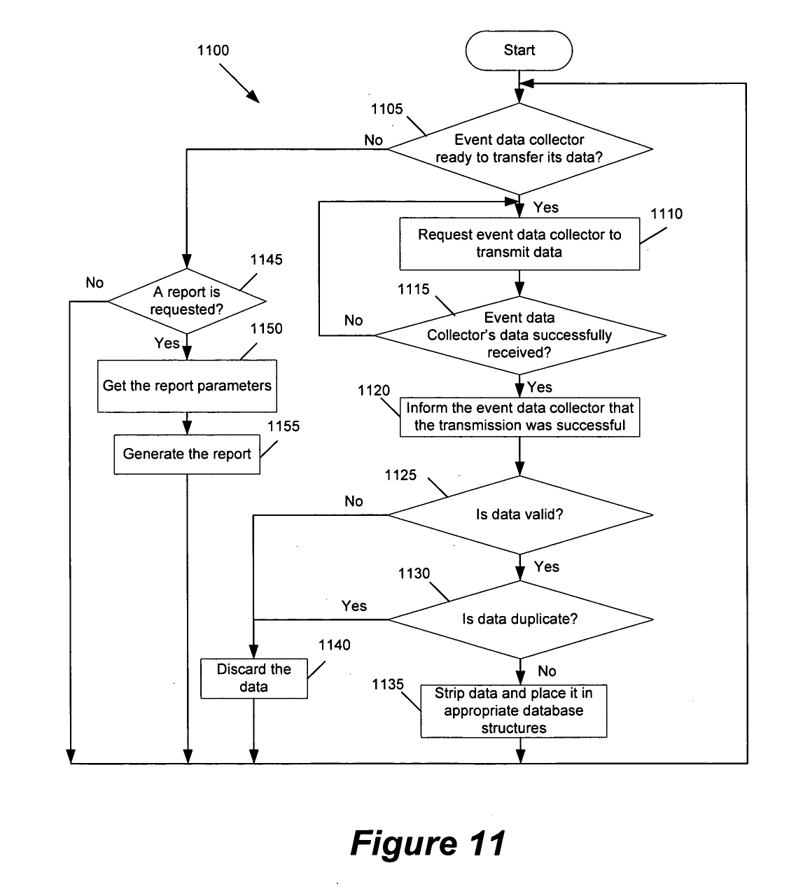

FIG. 11 conceptually illustrates a process 1100 utilized by the data collection computer of some embodiments to communicate with an event data collector. As shown, at 1105, the process checks whether the event data collector is ready to transfer its data. If the event data collector is not ready, the process proceeds to 945 which is described below. Otherwise, the process requests the event data collector to transmit its data. Next (at 1115), the process checks whether the transfer was successful. As indicated above, several methods such as the total number of bytes to transfer or an end of file indicator may be utilized to determine whether the transfer has been successful. If the transfer was not successful, the process returns to 1110 to request the event data collector to retransmit the data again.

Otherwise, if the transfer was successful, the process informs (at 1120) the event data collector that the data was successfully received. The process then checks (at 1125) if the received data is valid. If the data is invalid, the process discards the data (at 1140) and proceeds back to 1105. Otherwise, the process checks (at 1130) whether the data is duplicate. If the data is duplicate, the process proceeds to 1140 which was described above. Otherwise, the process strips data (at 1135) and places it in appropriate database structures. The process then returns back to 1105.

If (at 1105) the process determines that event data collector is not ready to transfer data, the process proceeds to 1145 to check whether a report is requested. If no report is requested the process proceeds to 1105. Otherwise, at 1150, the process gets the report parameters. For instance, the parameters may include the start and end date and time, specific PMDs, specific event, etc. Next (at 1155), the process generates the requested report. The process then proceeds back to 1105.

D. Hosting a Social Event

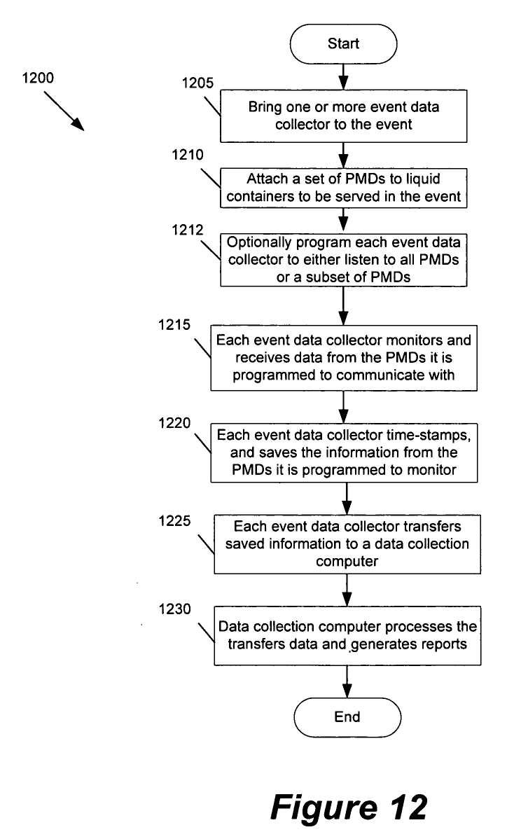

The catering system described above can be used to host a social event. FIG. 12 conceptually illustrates a method 1200 of hosting an event in some embodiments. As shown, (at 1205) one or more event data collectors are brought to the event. Next (at 1210), a set of PMDs are attached to liquid containers that will be served during the event.

At 1212, each event data collector is optionally programmed to either receive data from all PMDs or a subset of PMDs (e.g., by using process 1000 described in FIG. 10). In some embodiments, the PMDs are paired with the liquid container. For instance, in the embodiments that the liquid container has an RFID tag, the RFID tags are read by the PMD (e.g., by using process 1800 in FIG. 18, described below) and reported to the event data collector. In other embodiments, a UPC code on the container may be scanned (hand scanned or scanned by the event data collector) and used to mate the container to its corresponding PMD.

Next (at 1215), each event data collector monitors information transmitted by the PMDs that it is programmed to communicate with (i.e., either all PMDs or a subset of PMDs). The event data collector may use, e.g., process 900 shown in FIG. 9 to monitor and receive the information. The information may be liquid pour information or RFID information.

Next (at 1220), the event data collector time-stamps and saves the information form the monitored PMDs using the methods described above (e.g., by using process 900 shown in FIG. 9). At 1225, the saved information is transferred (e.g., by using process 900 shown in FIG. 9 and process 1100 shown in FIG. 11) from the event data collector to a data collection computer that is communicatively coupled to the event data collector. Finally (at 1230), the data collection computer further processes the data received from the event data collector and generates reports (e.g., by using process 1100 shown in FIG. 11).

III. All-In-One System

Some embodiments provide a liquid monitoring system with an all-in-one data collector unit. The data collector unit that communicates with PMDs would have a printer and enough processing power and storage to eliminate the need for a separate data collection computer. Although, it would still be possible to transfer liquid consumption data from an all-in-one system to other computers to aggregate liquid consumption data among several systems or to do more extensive report generation.

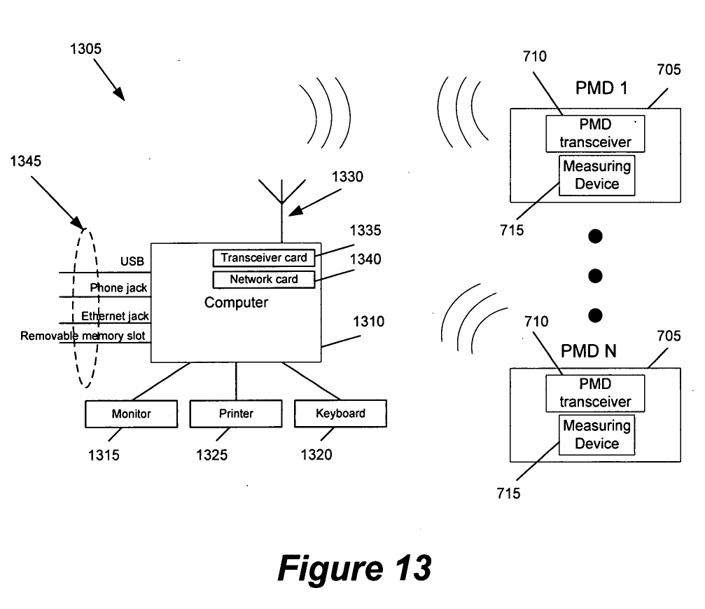

FIG. 13 illustrates an embodiment of a liquid monitoring system with an all-in-one data collector unit 1305. As shown, in this embodiment, a computer 1310 with monitor (in some embodiments the monitor is a touch screen) 1315, keyboard 1320, and external printer 1325 is used for communicating with PMDs, storing the received data, and generating reports. In some embodiments, the computer is dedicated for liquid monitoring tasks and activities unrelated to liquid monitoring are prevented. The computer 1310 connects to the antenna 1330 by using a radio transceiver (or in some embodiment, a receiver) 1335. In some embodiments, the antenna is a mat antenna as described with reference to FIG. 5 above. Similar to the catering system described above, more than one antenna may be used in the all-in-one system.

As shown in FIG. 13, a network card 1340 allows the computer to be connected to a network. The computer 1310 also has a set of communication ports 1345 to communicate with external computers. The communication ports may include USB, phone jack, Ethernet jack, removable memory slot, or other similar ports known to a person of ordinary skill in the art. Also, in some embodiments, the data collector may have a scanner (not shown) to scan the UPC codes of liquid containers.

Also, similar to the catering system described above, this monitoring system includes a set of PMDs 705. Each PMD has a transceiver 710. The PMD transceivers 710 communicate with the all-in-one data collector 1305 through the antenna 1330. In some embodiments, each PMD also has a measuring device 715. However, as described above, some PMDs (not shown) do not have a measuring device. In the embodiments that the PMD includes a measuring device, the measuring device 715 measures the amount of liquid that is poured from the corresponding container (not shown).

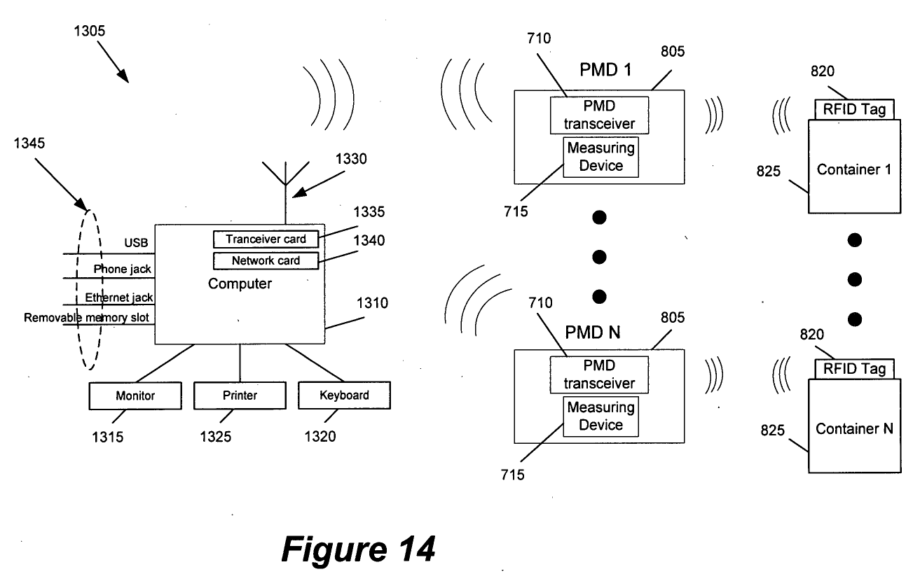

FIG. 14 illustrates another embodiment of the liquid monitoring system with an all-in-one data collector. This system is similar to the system illustrated in FIG. 13 with the additional feature that the PMDs 805 communicate with RFID tags 820 that are fitted on the liquid containers 825. As shown, in order to communicate with the PMD 805, each container of liquid 825 is fitted with an RFID tag 820. Each PMD communicates with the RFID tag on the particular container that the PMD is attached to. Other functions of the PMDs 805 are similar to the PMDs 705 described above.

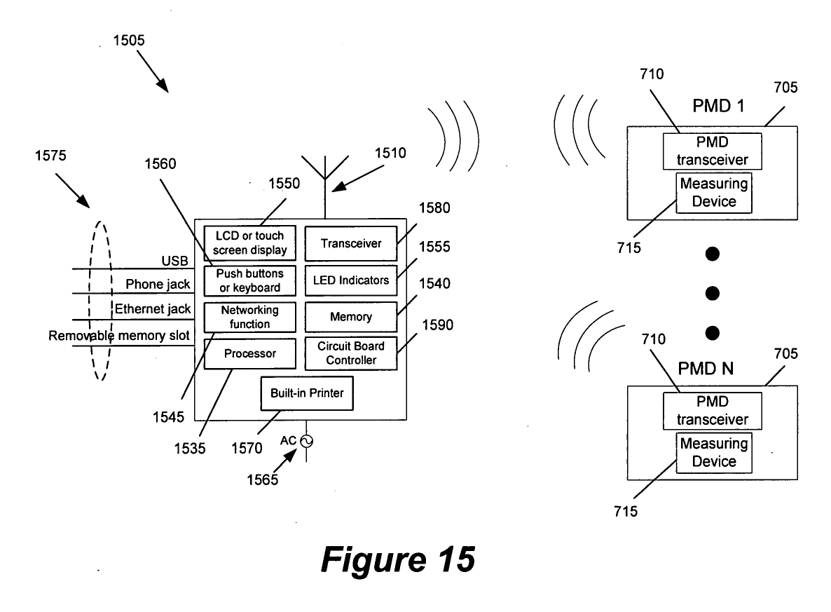

FIG. 15 illustrates another embodiment of the liquid monitoring system with an all-in-one data collector. This system has a custom-made all-in-one data collector unit 1505. As shown, similar to other embodiments described above, this monitoring system includes a set of PMDs 705. Each PMD has a transceiver 710 and a measuring device 715. The PMD transceivers 710 communicate with the all-in-one data collector 1505 through the antenna 1510. In some embodiments, the antenna is a mat antenna as described with reference to FIG. 5 above. Similar to the catering system described above, more than one antenna may be used in the all-in-one system. Also, in some embodiments, the custom-made all-in-one system has an additional built-in antenna.

As shown in FIG. 15, the all-in-one data collector unit 1505 includes a processor 1535, memory (both volatile and non-volatile) 1540, networking function 745 (either built-in networking capability or a network card), 1545, an LCD display (some embodiments have a touch screen instead of the LCD display) 1550, a set of LED indicators 1555, a set of push buttons (or a keyboard) 1560, a transceiver (or in some embodiment, a receiver) 1580 to connect to the antenna 1510, an AC adaptor 1565, and a circuit board controller 1590 to handle I/O and data communication. The unit 1505 also has a set of communication ports 1575 which enables to communicate to other computers for data transfer (e.g., to allow data consolidation or more extensive report generation). The communication ports may include USB, phone jack, Ethernet jack, removable memory slot, or other similar ports known to a person of ordinary skill in the art.

In some embodiments, the all-in-one data collector unit 1505 includes a built-in printer 1570. In some embodiments, this built-in printer is within the housing of the all-in-one data collector. In other embodiments, an external printer (not shown) is used. The system has enough non-volatile memory to permanently store the liquid consumption data. Some embodiments use a keyboard instead of push buttons for the operator input. Some embodiments allow for color LCD or other type of displays such as CRTs. Also, in some embodiments, the data collector may have a scanner (not shown) to scan the UPC codes of liquid containers.

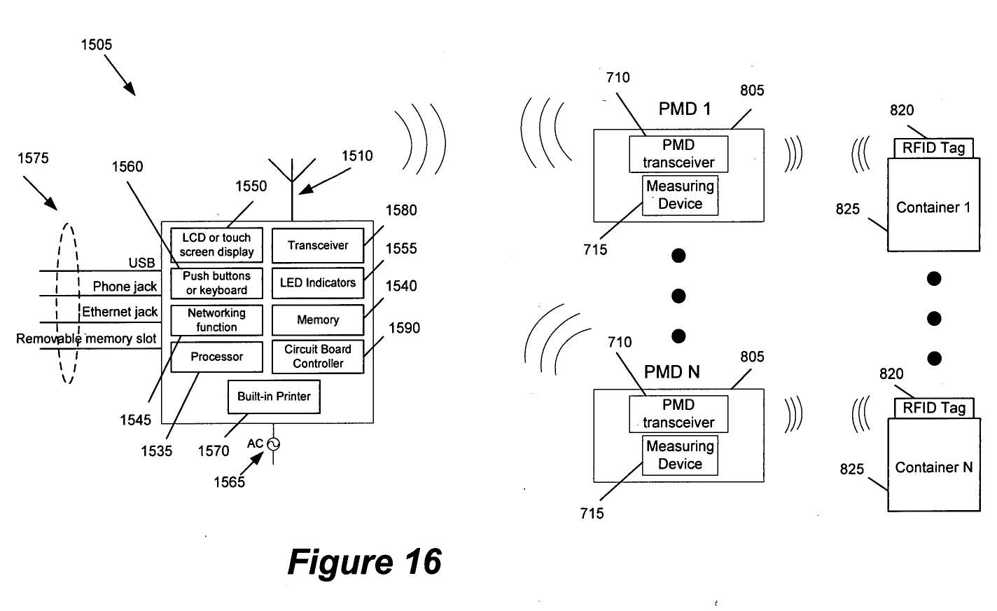

FIG. 16 illustrates another embodiment of the liquid monitoring system with an all-in-one custom-made data collector. This system is similar to the system illustrated in FIG. 15 with the additional feature that the PMDs 805 communicate with RFID tags 820 that are fitted on the liquid containers 825. As shown, in order to communicate with the PMD 805, each container of liquid 825 is fitted with an RFID tag 820. Each PMD communicates with the RFID tag on the particular container that the PMD is attached to. Other functions of the PMDs 805 are similar to the PMDs 705 described above.

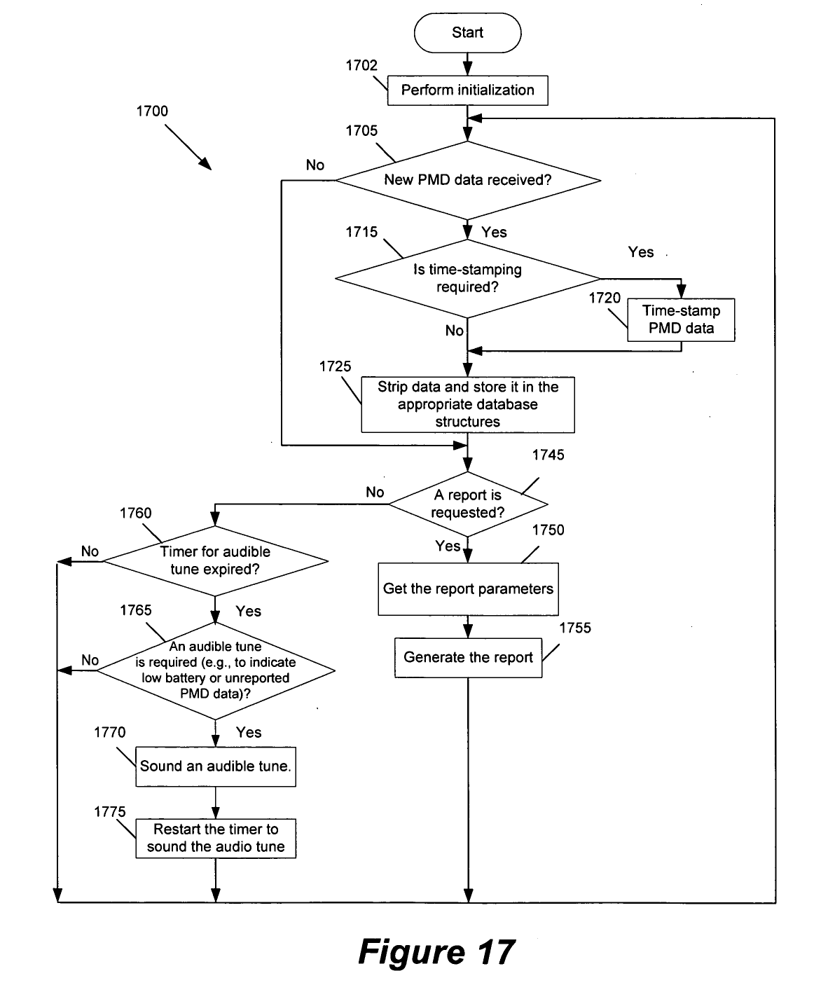

FIG. 17 conceptually illustrates a process 1700 of all-in-one data collectors of some embodiments. At 1702, when process 1700 is first started, the process performs initialization. For instance, as described above, some embodiments sound an audible tune to inform an operator of certain system status. As a part of initialization, the process 1700 starts a timer to periodically check if an audible tune is required. The use of this timer is described below.

Next (at 1705), the process checks whether new PMD data is received. If no new data is received, the process proceeds to 1745 which is described below. Otherwise, the process checks (at 1715) whether time-stamping is required. If no time-stamping is required, the process proceeds to 1725. Otherwise, the process time-stamps (at 1720) the data with the current time and date. Next (at 1725) the process strips data and saves it in the appropriate database structures.

Next (at 1745), the process checks if a report is requested. If no report is requested the process proceeds to 1760 which is described below. Otherwise, at 1750, the process gets the report parameters. For instance, the parameters may include the start and end date and time, specific PMDs, specific event, etc. Next (at 1755), the process generates the requested report. The process then proceeds back to 1705.

If after 1745, the process proceeds to 1760, the process checks whether the timer for sounding the audible has expired. If the timer is not expired, the process proceeds to 1705. Otherwise, the process checks (at 1765) whether an audible tune is required. As described above, some embodiments sound an audible tune (e.g., when the unit is not connected to the antenna) to alert the operator with certain status condition. These status conditions are sensed by a set of sensors. These sensors inform the data collector processor of the specific status. For instance, if the unit is not connected to the antenna, the sensor informs the processor. Later on, when the unit is connected to the antenna, the processor is informed again. The processor is informed (not as a part of process 1700) by the sensor through either an interrupt or similar methods known by a person of ordinary skill in the art. The processor sets or resets a series of software flags which are later on used by process 1700 to sound the audible tune. In the embodiments that the all-in-one data collector is a custom-made unit with LEDs, the processor also turns the corresponding LED lights on or off to indicate the status (not as a part of process 1700). Therefore, at 1765, the process 1700 checks these software flags to determine if an audible tune is required. If no tune is required, the process proceeds to 1705. Otherwise, at 1770, the process sounds an audible tune. Next (at 1775), the process restarts the timer for the audio tune. The process then proceeds back to 1705.

In some embodiments, the all-in-one data collector can be programmed to recognize and communicate with certain PMDs. These embodiments utilize a process similar to process 1000 described above to program the all-in-one data collector. In some embodiments, the data collector keeps tracks of the PMDs that are communicating with it and generates an alarm when the PMD is taken out of the range of the data collector. The alarm may be in the form of an audible sound, an indicator light turned on, a display message, or an alarm internally kept within the system.

IV. Pour Monitoring Device Functions

A. Reading Liquid Container's RFID Tag

Some embodiments utilize RFID tags to store information such as manufacturer, product type, container size, shipping information, serial numbers, etc. In these embodiments, some PMDs may contain electronics to act as RFID tag transceivers. When such a PMD is placed on a container of liquid, a container contact sensor on the PMD activates the RFID transceiver. FIG. 18 presents a process 1800 that conceptually shows how a PMD reads a container's RFID tag in some embodiments. This process only handles PMD and RFID tag interactions. Other PMD functions, such as measuring the amount of liquid poured, are described in the above mentioned U.S. Pat. No. 6,892,166. Also, the process 1800 is for a PMD that uses its internal memory to store RFID information. A process for PMDs that do not save RFID information is described further below.

At 1805, the process 1800 activates the transceiver (e.g., upon placing the PMD on the container). At 1810, any previous values of RFID stored in PMD memory are cleared. Next, at 1815, the PMD sends a radio signal to activate the RFID tag on the liquid container. At 1820, the RFID tag transmits its data. If the PMD determines (at 1825) that it has received the RFID data, it proceeds to 1835 which is described below. Otherwise, the PMD transmits (at 1830) an indication to the data collector (e.g., 730, 1305, or 1505) that no response is received after a signal to active the RFID tag is sent. The process then proceeds to 1860 which is described below.

If after 1825 the process proceeds to 1835, the process determines (at 1835) whether the RFID value has changed. The PMD does this by comparing the received value with the stored value of the RFID tag. If the RFID value has changed, the process proceeds to 1850 which will be described below. Otherwise, the PMD processor determines (at 1840) whether it is required to inform the data collector (730, 1305, or 1505) that the RFID tag value has not changed. In some embodiments, the data collector requires an indication that the tag value is read but has not changed. In these embodiments, the PMD transmits (at 1845) an indication that RFID tag information has not changed. Otherwise, if no transmission is required, the process proceeds to 1860 which is described below.

If after 1835 the process proceeds to 1850, the PMD processor saves RFID tag information in PMD memory. Next at 1855, the PMD attaches its unique ID to the RFID data and transmits the RFID tag information to the data collector. The PMD then proceeds to 1860 and starts a timeout during which the process 900 goes to a wait state. After the expiration of the timeout, the PMD processor proceeds back to 1815 to read the RFID data again.

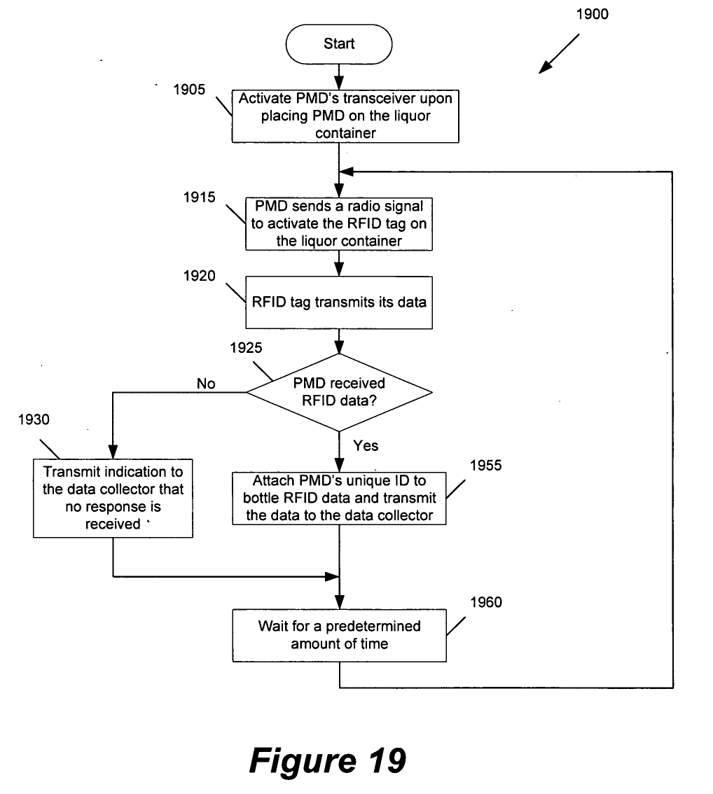

FIG. 19 illustrates another process 1900 that some embodiments utilize to read the RFID tag information. This process is utilized by the PMDs that do not store the RFID data in their internal memory. As shown, upon placing the PMD on the liquid container (at 1905), the PMD's transceiver is activated. Next, at 1915, the PMD sends a radio signal to activate the RFID tag on the container. At 1920, the RFID tag transmits its data. Next, the PMD determines (at 1925) whether it has received the RFID data. If the PMD has received the RFID data, it attaches (at 1955) its unique ID to the RFID data received from the tag and transmits the data to the monitoring system transceiver. The process then waits (at 1960) for a predetermined period of time and proceeds to 1915. If the PMD determines (at 1925) that the RFID data is not received, it transmits (at 1930) an indication to the external transceiver that no response is received after a signal to active the RFID tag is sent. The process then proceeds to 1960 which was described above.

B. Programming RFID Tags

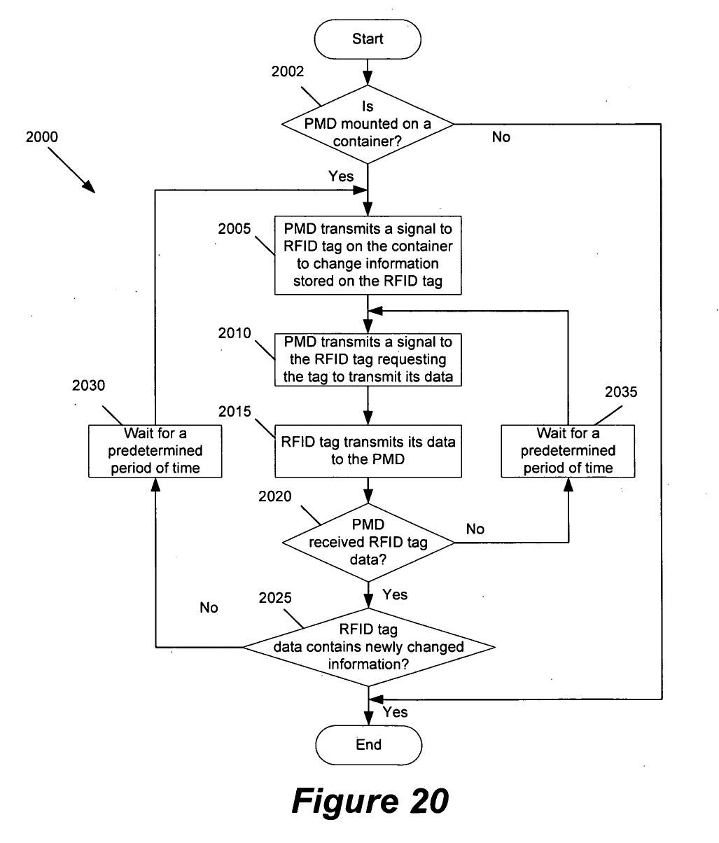

Some embodiments utilize active RFID tags that are capable of storing information received from the PMD transceiver. This information may either exist within the PMD or may be transmitted to the PMD by the external transceiver. FIG. 20 illustrates a process 2000 that some embodiments utilize to program the RFID tags on liquid containers. At 2002, the process 2000 checks whether the PMD is mounted on a container. If the PMD is not attached to a container, the process exits. On the other hand, if the PMD is connected to a container, the PMD transmits (at 2005) a signal to the RFID tag on the container to change information stored on the RFID tag. The signal includes the new information to be stored on the tag. For instance, in some embodiments, the new information includes the PMD's unique identification.

Next, at 2010, the PMD transmits a signal to the RFID tag requesting to receive the data stored on the tag. At 2015, the RFID tag transmits its data. At 2020, the PMD checks if it has received the RFID tag data. If the RFID tag data is not received, the process waits (at 2035) for a predetermined period of time and then proceeds to 2010 to request the RFID data again. If on the other hand, the RFID data is received from the tag, the process checks (at 2025) whether the RFID tag data contains the data the PMD had sent to the tag at 2005. If the tag data is updated to contain the new information, the process exits. Otherwise, the process waits (at 2030) for a predetermined period of time. The process then proceeds to 2005 to retransmit the data again. In some embodiments (not shown in FIG. 20), if the tag data does not contain the new information, the PMD generates an error code to be transmitted to the data color unit.

C. Measuring the Amount of the Liquid Poured

As described above, the measuring apparatus in each PMD provides data relating to the amount of liquid poured from the container affixed to the PMD. In some embodiments, the PMDs are free-pour spouts, allowing liquid to be poured without restricting flow or limiting quantities. In other embodiments, the PMDs are restricted pour spouts, limiting liquid to be poured to a certain per-determined quantity. Detail description of the above mentioned spout functions is described in the U.S. Pat. No. 6,892,166, entitled “Method, Apparatus, and System for Monitoring Amount of Liquid Poured from Liquid Containers” issued on May 10, 2005 and U.S. Pat. No. 6,036,055 entitled, “Wireless Liquid Portion and Inventory Control System” issued on Mar. 14, 2000.

Yet, in other embodiments, PMDs are not spouts and measure the amount of liquor poured by other methods such as measuring the time of tilt or using one of several other computer estimation techniques. For instance, in some embodiments, the amount poured is computed based on the time the container is tilted into a pouring position. Each time the container is tilted for pouring, or returned to an upright position, the PMD reports the angle of tilt to the data collector. The amount poured is computed, either by the data collection computer (120) or by the data collector (205/305), based on information such as the tilt angle, duration of time that the container was at that angle, and the size of the container. More information about measuring the amount of liquor poured is given in the above mentioned concurrently filed U.S. Patent Application, Attorney Docket No. CPTN.P0006, entitled “System for Beverage Dispensing and Sales Tracking”.

V. Computer System

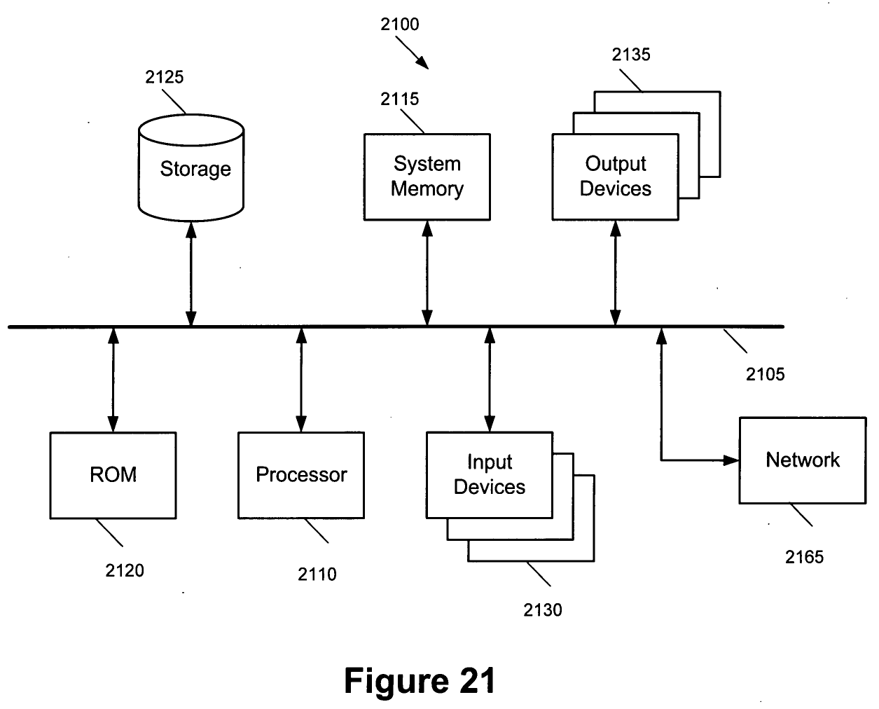

FIG. 21 conceptually illustrates a computer system with which one embodiment of the invention is implemented. Computer system 2100 includes a bus 2105, a processor 2110, a system memory 2115, a read-only memory 2120, a permanent storage device 2125, input devices 2130, and output devices 2135.

The bus 2105 collectively represents all system, peripheral, and chipset buses that support communication among internal devices of the computer system 2100. For instance, the bus 2105 communicatively connects the processor 2110 with the read-only memory 2120, the system memory 2115, and the permanent storage device 2125.

From these various memory units, the processor 2110 retrieves instructions to execute and data to process in order to execute the processes of the invention. The read-only-memory (ROM) 2120 stores static data and instructions that are needed by the processor 2110 and other modules of the computer system. The permanent storage device 2125, on the other hand, is a read-and-write memory device. This device is a non-volatile memory unit that stores instruction and data even when the computer system 2100 is off. Some embodiments of the invention use a mass-storage device (such as a magnetic or optical disk and its corresponding disk drive) as the permanent storage device 2125. Other embodiments use a removable storage device (such as a floppy disk or zip® disk, and its corresponding disk drive) as the permanent storage device.

Like the permanent storage device 2125, the system memory 2115 is a read-and-write memory device. However, unlike storage device 2125, the system memory is a volatile read-and-write memory, such as a random access memory. The system memory stores some of the instructions and data that the processor needs at runtime. In some embodiments, the invention's processes are stored in the system memory 2115, the permanent storage device 2125, and/or the read-only memory 2120.

The bus 2105 also connects to the input and output devices 2130 and 2135. The input devices enable the user to communicate information and select commands to the computer system. The input devices 2130 include alphanumeric keyboards and cursor-controllers. The output devices 2135 display images generated by the computer system. For instance, these devices display IC design layouts. The output devices include printers and display devices, such as cathode ray tubes (CRT) or liquid crystal displays (LCD).

Finally, as shown in FIG. 21, bus 2105 also couples computer 2100 to a network 2165 through a network adapter (not shown). In this manner, the computer can be a part of a network of computers (such as a local area network (“LAN”), a wide area network (“WAN”), or an Intranet) or a network of networks (such as the Internet). Any or all of the components of computer system 2100 may be used in conjunction with the invention. However, one of ordinary skill in the art will appreciate that any other system configuration may also be used in conjunction with the invention.

While the invention has been described with reference to numerous specific details, one of ordinary skill in the art will recognize that the invention can be embodied in other specific forms without departing from the spirit of the invention. In other places, various changes may be made, and equivalents may be substituted for elements described without departing from the true scope of the present invention. Thus, one of ordinary skill in the art would understand that the invention is not limited by the foregoing illustrative details, but rather is to be defined by the appended claims.

1. A method of hosting an event, the method comprising:
a) bringing a portable data collector to the event;
b) attaching a set of pour monitoring devices (PMDs) to a set of liquid containers;
c) transmitting liquid pour information by PMDs to the portable event data collector;
d) time-stamping and saving the pour data by the event data collector;
e) transferring the saved pour data from the event data collector to a data collection computer that is communicatively coupled to the event data collector.

2. The method of claim 1, wherein said communicatively coupling of the portable event data collector and the data collection computer is performed after the event by taking the event data collector to proximity of the data collection computer and linking them through a wireless communication connection.

3. The method of claim 1, wherein said communicatively coupling of the portable event data collector and the data collection computer is performed after the event by taking the event data collector to proximity of the data collection computer and linking them through a hardwired connection.

4. The method of claim 1, wherein said communicatively coupling of the portable event data collector and the data collection computer is performed by communicatively coupling the event data collector and the data collection computer through the Internet.

5. The method of claim 1, further comprising:
a) sending an indication from the data collection computer to the event data collector indicating that said transferring of pour data has been successful;
b) discarding by the event data collector said saved pour data after receiving said indication from the data collection computer.

6. The method of claim 1, further comprising:
a) sending an indication from the data collection computer to the event data collector indicating that said transferring of pour data has not been successful;
b) resending said saved pour data by the event data collector after receiving said indication from the data collection computer.

7. The method of claim 1, further comprising:
a) processing the pour data by the data collection computer;
b) generating reports by the data collection computer.

8. The method of claim 1, further comprising:
programming the event data collector to only store data received from a first subset of the PMDs and to ignore data from all other PMDs not in said first subset.

9. The method of claim 8, wherein said programming is comprised of:
a) putting the event data collector into a listening mode;
b) making each PMD to transmit an identification to the event data collector;
c) displaying one or more options to an operator to select whether the event data collector shall store or ignore the data from a particular PMD;
d) selecting one of said option by the operator.

10. The method of claim 9, wherein said options further include an option to program the event data collector to store data from all PMDs during the event.

11. A system for monitoring liquid consumption at an event, the system comprising:
a) a set of pour monitoring devices (PMDs), wherein each PMD is for mounting on a liquid container, wherein each PMD is for generating data regarding the amount of liquid poured from the PMD's container; and
b) an event data collector comprising a memory and a set of batteries, wherein the event data collector is communicatively coupled to the PMDs;
wherein the PMDs transmit liquid pour information to the event data collector;
wherein the event data collector time-stamps and stores said liquid pour information in the memory;
wherein the event data collector sends said liquid pour information to a data collection computer for further processing when the event data collector and the data collection computer are communicatively coupled.

12. The system of claim 11, wherein the batteries are rechargeable.

13. The system of claim 11, wherein the event data collector also works on AC power.

14. The system of claim 11, wherein the event data collector stores said time-stamped data if there is no communication link established between the data collection computer and the event data collector at the time that the event data collector receives said data from the PMDs.

15. The system of claim 11, wherein the event data collector transmits the data to the data collection computer in real-time if there is a link established between the data collection computer and the data collector at the time the receiver receives the data.

16. The system of claim 15, wherein the event data collector turns off time-stamping if the event data collector the data is transferred to the data collection computer in real-time.

17. The system of claim 11, wherein the data collection computer communicates with a plurality of receivers.

18. The system of claim 17,
wherein the data collection computer listens for event data collectors seeking to transmit data;
wherein the data collection computer receives data from each event data collector;
wherein the data collection computer confirms data transfer.

19. The system of claim 11, wherein the data collection computer eliminates duplicate data received from the event data collector.

20. The system of claim 11, wherein the event data collector and the data collection computer communicate via a network.

21. The system of claim 11, wherein the data collection computer and the event data collector communicate directly with each other without the use of a network.

22. The system of claim 11, the system further comprising a plurality of light indicators to show system status.

23. The system of claim 20, wherein the light indicators are LED.

24. The system of claim 11, wherein the PMDs are pour spouts.
